(19) United States
(12) Patent Application Publication
(10) Pub. No.: US 2024/0365754 A1
(43) Pub. Date: Nov. 7, 2024

(54) DOG HARNESS

(71) Applicant: Pug Life Harness Branding, Inc., Los Angeles, CA (US)

(72) Inventor: Sanez Pezeshki, Los Angeles, CA (US)

(21) Appl. No.: 18/312,480

(22) Filed: May 4, 2023

(51) Int. Cl. A01K 27/00

(52) U.S. Cl. CPC A01K 27/006; A01K 27/002

(57) ABSTRACT

An improved animal harness is disclosed. The improved animal harness includes a harness body, an abdomen strap, a breast strap, reflective elements, a controller, power source, and light sources for aesthetics and safety in low-light conditions.

### NOTICE OF COPYRIGHTS AND TRADE DRESS

A portion of the disclosure of this patent document contains material which is subject to copyright protection. This patent document may show and/or describe matter which is or may become trade dress of the owner. The copyright and trade dress owner has no objection to the facsimile reproduction by anyone of the patent disclosure as it appears in the Patent and Trademark Office patent files or records, but otherwise reserves all copyright and trade dress rights whatsoever.

### BACKGROUND

### Field

The field of the invention is animal harnesses.

This disclosure relates to an improved animal harness that may include reflective piping, lights for aesthetics and visibility, power for the lights, and controls for the lights.

### Description of the Related Art

Animal harnesses, and dog harnesses in particular, are known. A common dog harness version has a distinct “Y” configuration. A strap passes underneath the abdomen of the dog and connects to a Y strap on the dog's back, where the arms of the Y each extend behind the dog's neck and cross over the top of the dog's shoulders to join with the first strap underneath the dog's abdomen.

Many other dog harnesses on the market today use a two-strap design where one strap starts on the back and passes across the front of the dog's breast. The other strap starts on the back of the dog and passes underneath the abdomen of the dog. The straps are joined on the dog's back to make one harness.

An alternative to that design provides a central harness body of webbing or padding on the back of a dog. The abdominal strap and the breast strap then connect to that central harness body on the back of the dog.

A further alternative uses two harness bodies, one on the back and one on the abdomen of a dog. The straps connect the two harness bodies together. This arrangement can create a hybrid connection across the shoulders and breast of a dog. The straps connecting the back harness body to the abdominal harness body extend behind the dog's neck and cross over the top of the dog's shoulders, like in a Y harness design. However, the straps can then connect to the abdominal harness, which is disposed across the breast of the dog and extending posteriorly to meet the abdominal straps of the back harness. In this way the harness crosses over the shoulders of the dog, like a Y harness, but allows pressure to be distributed more evenly across the breast of the dog, like a two-strap design. The abdominal strap connects the back harness body and abdominal harness body towards the posterior of the dog.

The addition of lights on a dog harness for aesthetics and safety is a new advance, and the subject of considerable innovation and invention.

### THE DRAWINGS

FIG. 1 is a perspective view of the left-hand side of the animal harness.

FIG. 2A is a side view of the right-hand side of the animal harness.

FIG. 2B is a detailed view of a leash for the animal harness.

FIG. 3 is an overhead view of the animal harness.

Throughout this description, elements appearing in figures are assigned three-digit reference designators, where the most significant digit is the figure number and the two least significant digits are specific to the element. An element that is not described in conjunction with a figure may be presumed to have the same characteristics and function as a previously-described element having a reference designator with the same least significant digits.

### DETAILED DESCRIPTION

### Description of Apparatus

An improved animal harness particularly useful with dogs and other house pets such as cats and rabbits is described herein. The harness may include reflective piping for safety and lights for aesthetics and visibility. The harness may include power for the lights and a control unit for the lights.

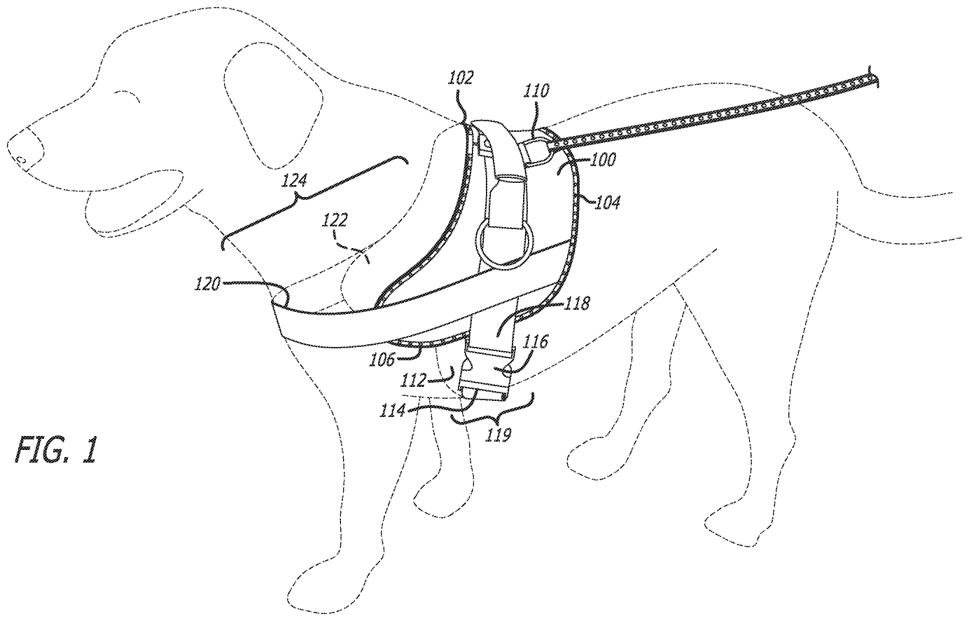

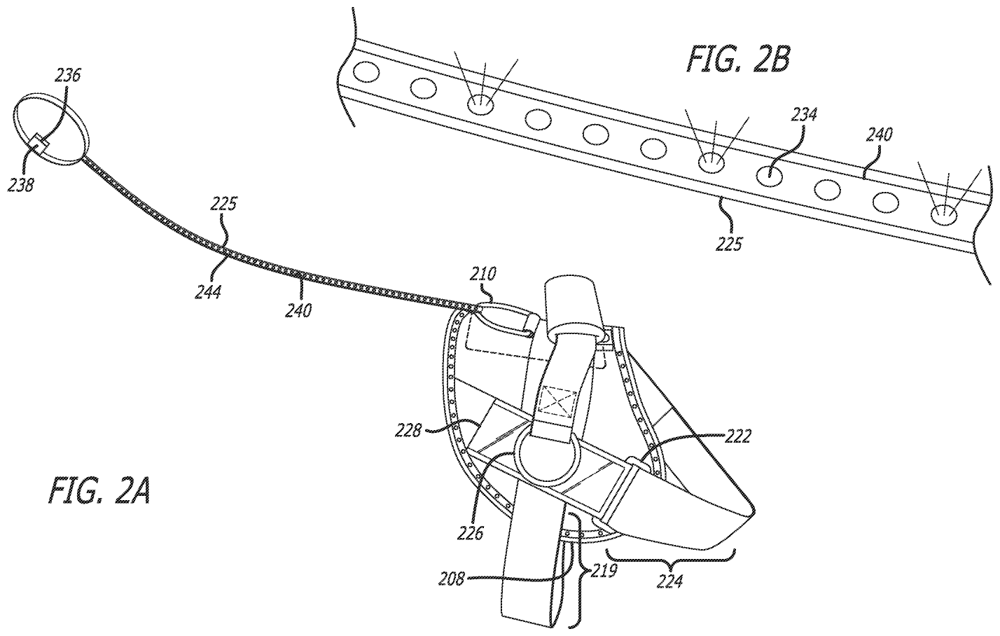

Referring now to FIGS. 1, 2A, and 2B, there is shown a perspective view from ahead and to the left of an animal wearing an improved animal harness. A harness body 100 is configured to partially wrap around the animal covering a portion of the back and sides of the animal. The harness body 100 has a front edge 102, a back edge 104, and side edges 106 and 208. The edges 102, 104, 106, and 208 are contiguous and form a perimeter around the harness body 100. The harness body may be composed of a suitable material, such as, but not limited to, leather, cloth, cotton, wool, nylon, polyester, neoprene, polypropylene, Cordura®, Dyneema®, or webbing (i.e., strong fabric woven as a flat strip or tube, often made of hemp, cotton, linen, or synthetic fibers). The harness body 100 may also be composed of other suitable materials, including padded material composed of foam padding, 3D sandwich mesh, polyester, polyester fleece, polyether, polystyrene, polyurethane, polyethylene, or vinyl; or cushioned materials (such as a harness body 100 stuffed with polyester, polyether, polystyrene, polyurethane, or polyethylene; cloth) leather; or any other material suitable to be used as an animal harness. The harness body 100 may have a top side and a bottom side, wherein the top side is composed of a material selected for its durability and the bottom side is selected for softness and the comfort of the animal. The harness body may be augmented to include reflective and/or glow in the dark materials.

Coupled to or otherwise included with the harness body 100 is a connector 110 for a rope, leash, chain, or other apparatus to lead or tether an animal. The harness body 100 and the connector 110 may be attached to one another by stitching the connector 110 to the harness body 100, or attaching by adhesive, pressure-fixed, rivets, heat application, webbing, zipper(s), buttons, buckles, toggles, snaps, hook and loop fasteners, clips, or with other devices and techniques. Similarly, the connector 110 may be any component capable of accepting an animal lead or tether, such as a metal ring, webbing, loop (of any of the materials described above with respect to harness body 100, including fabrics and leathers), zipper, button, buckle, toggle, snap, hook and loop fasteners, or clip. In some embodiments the lead or tether may be directly integrated into the harness body 100 such that the lead or tether is not capable of being removed from the harness body.

In one embodiment the harness body 100 is composed of a 3D sandwich mesh material such as polyester, polyether, polystyrene, polyurethane, or polyethylene and the connector 110 is a metal ring attached to the harness body by adhesives, webbing, or stitching.

The harness body 100 is connected to an abdominal strap 112 that extends from a side edge (106 or 208) of the harness body 100. The abdominal strap 112 has connector 114 at its distal end. Complimentary connector 116 is attached to the harness body 100 at the opposite side edge (106 or 208) from the connection point of strap 112 to the harness body 100. Connectors 114 and 116 may be composed of any of the materials discussed in relation to connector 110, above. The abdominal strap 112 is long enough to pass under the abdomen of the animal and connect connector 114 with complementary connector 116. Connector 116 may be directly connected to the harness body 100 or it may be attached at the distal end of strap 118 extending from the harness body 100.

The abdominal strap 112 and optional strap 118 may be formed from one strap that extends across the top of the harness body 100 and attached to it via adhesive or stitching. The abdominal strap 112 and optional strap 118 may be composed of any of the materials discussed above with respect to the harness body 100, including but not limited to, fabrics, leather, 3D sandwich mesh, and webbing.

Together, the abdominal strap 112, connector 114, connector 116 (and optional strap 118) compose the ventral strap 119. The ventral strap 119 may be composed of or augmented with reflective or glow in the dark materials.

Ventral strap 119 is adjustably resizable. It may be resized by pulling the ventral strap 119 tighter or looser using connector 114 and securing the excess abdominal strap (not shown) so that it does not drag on the ground or flap loose. In one embodiment, the connector 114 is a buckle; tension in the abdominal strap 112 is held by friction, and the excess abdominal strap is clipped to abdominal strap 112. In other embodiments the connector 114 is composed of snaps, buttons, buckles, hook and loop fasteners, or other connectors. Similarly, the excess abdominal strap may also be secured to abdominal strap 112 through the use of a keeper loop, elastic loop, strap keeper, buttons, snaps, hook and loop fasteners, or other suitable components.

The harness body 100 is connected to a breast strap 120 that extends from an off-center portion of front edge 102 of the harness body 100. The breast strap 120 is composed of hook and loop fasteners along at least a portion of its length. Complimentary connector 122 (not shown in FIG. 1 but shown in FIG. 2A as element 222) is attached to the harness body 100 off-center and on the opposite lateral side from the point at which breast strap 120 connects to the harness body 100. The breast strap 120 is long enough to pass from approximately the shoulder of an animal, across the breast, and connect to the harness body at approximately the other shoulder of the animal. The breast strap 120 may be composed of any of the materials discussed above with respect to the harness body 100, including but not limited to, fabrics, leather, 3D sandwich mesh, and webbing. In one embodiment, connector 122 is a square metal loop, breast strap 120 is threaded through the connector 122, and the excess breast strap 120 is secured to itself using hook and loop fasteners. In this way, the excess strap does not drag or flap, and breast strap 120 is adjustably resizable.

The breast strap 120 may extend across the top of the harness body 100 along its sides and substantially parallel to the side edges 106 and 208 and attach to the harness body 100 via adhesive or stitching.

Together, breast strap 120 and connector 122 compose the front strap 124. Front strap 124 may be composed of or augmented with reflective or glow in the dark materials.

The embodiments of ventral strap 119 and front strap 124 may be the same or different. Ventral strap 119 may be composed of the same embodiment as front strap 124 or the ventral strap 119 may be composed differently from front strap 124. In other words, ventral strap 119 may be composed as front strap 124 was described above, and front strap 124 may be composed as ventral strap 119 was described above, or vice versa, or they may both be composed of the embodiments of one, or of the other.

Referring now to FIGS. 2A and 2B, there is shown a side view from the right of an animal wearing an improved animal harness. Side edge 208 is the other side edge of harness body 100 from side edge 106. Connector 210 is the same element as connector 110 described in FIG. 1. Connector 222 is the same element as connector 122 described in FIG. 1. Connector 226 is a side connector. It is connected to the harness body 100 at a position that is laterally off-center adjacent to the side of the dog or other animal. Connector 226 may be attached to harness body 100 in the same manner as connector 110, described above. Further, connector 226 may be composed in the same way and of the same materials as was described with respect to connector 110.

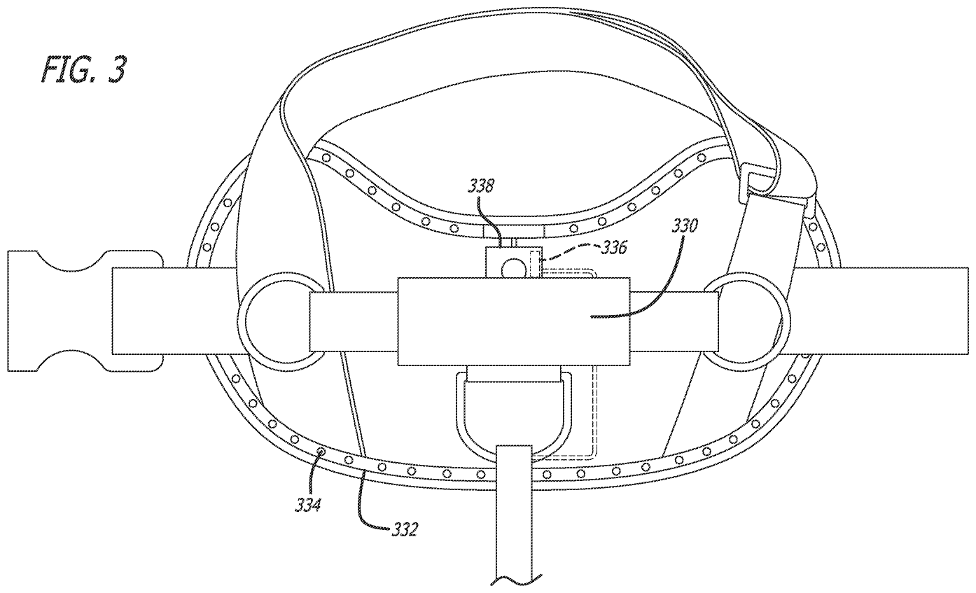

An animal tether or lead 225 has a proximal end capable of attaching to connectors 210 or 226 in order to lead, tether, or leash an animal. The lead 225 may be composed of a suitable material, such as webbing, (i.e., strong fabric woven as a flat strip or tube, often made of hemp, cotton, linen, or synthetic fibers), a metal chain, leather, or a rubber bungie, and may include or be augmented with reflective or glow in the dark materials. In one embodiment the lead 225 is connected to connectors 210 or 226 at its proximal end. In this embodiment, a power source 236 and control unit 238 are provided at the distal end of lead 225. Referring now to FIGS. 2A, 2B, and 3, control unit 238 is electrically connected to the lights 334 by a cable 244 that extends from the distal end of lead 225 down the length of lead 225 to the proximal end of the lead 225 and connects to the lights 334. The cable 244 may be situated inside the lead 225 or run alongside of it.

Referring to FIGS. 1, 2A, 2B, and 3, the power source 236 and control unit 238 located at the distal end of lead 125 may replace or be in addition to the power source 336 and control unit 338 attached to the harness body 100.

Returning to FIGS. 2A and 2B, in one embodiment, reflective piping 240 may be integrated into the lead 225. In another embodiment lights 234 may be integrated into or connected to reflective piping 240 and connected to power unit 236 and control unit 238.

A clear plastic sleeve 228 is attached to the harness body 100. Clear plastic sleeve 228 is disposed with one open end such that paper or other flat material can be slipped inside the clear plastic sleeve 228. This allows the animal harness to be customized by the user inserting paper or other flat material with words, drawings, or designs into the clear plastic sleeve 228. Not only does the clear plastic sleeve allow for the display of customized names, messages, drawings, pictures, and the like, the sleeve protects the contents from degradation from weather such as sun, water and snow.

Referring now to FIG. 3, there is shown an overhead view from behind an animal wearing an improved animal harness. In one embodiment, a handle 330 is attached to the harness body 100. The handle 330 may be attached horizontally, that is, parallel to the back edge 104, or vertically, that is, at right angles to the back edge 104, or at any angle in between. In a preferred embodiment, handle 330 is attached so that it is bilaterally symmetrical with the harness body 100. The handle 330 can be permanently attached to the harness body 100 or removably attached. The handle 330 can be attached to the harness body 100 using any of the methods described above regarding the connection between abdominal strap 112 and harness body 100 or between breast strap 120 and harness body 100. Handle 330 may be composed of or augmented by reflective or glow in the dark materials or any of the materials described with respect to harness body 100.

The harness body 100 may include or have attached thereto reflective piping 332. In one embodiment the reflective piping is arranged around the perimeter of the harness body 100. In another embodiment the reflective piping 332 is composed of light emitting elements/devices referred to as lights. The lights illuminate the piping. In one embodiment, the lights 334 are included within the reflective piping 332 and illuminate it from inside. In other embodiments, the lights 334 are outside the reflective piping 332 and illuminate the reflective piping 332, harness body 100, animal, and/or the surrounding area.

The lights may be LEDs, RGB LEDs, RGBW LEDs, RGBWW LEDs, and/or OLEDs, and may be arrange in combination as light strings, LED light string, light tape, LED light tape, light strips, LED light strips, and the like. The lights 334 may be connected with light strings, light pipe strips or piping. The lights 334 may be capable of producing one ore multiple colors of light. Further, the lights 334 may be spaced at intervals within the piping. The lights 334 may be capable of continuous lighting and/or blinking, in any pattern. For example, the lights 334 may blink slowly, quickly, intermittently, or at other tempos. In embodiments with lights of one or more colors, or lights that can change colors, other example patterns include alternating colors, colors that smoothly blend into each other, or other color-shifting patterns. Further, the response time of the lights 334 may be varied to provide changes in the lights that vary between staccato blinks or smooth transitions between intensities or colors. Moreover, the tempo, rhythm, color-shifting patterns, and response time may all be varied to produce other patterns. In addition, the reflective piping 332 (with or without lights 334) may be arranged in other patterns and areas on the harness body for aesthetic effect or further visibility.

The lights require a power source and, in some embodiments, are coupled with or connected to a controller or control unit. In one embodiment, the control unit 338 contains circuitry and components for controlling the lights 334 along with a power source. The power source can be a conventional battery and may be replaceable or rechargeable, such as through USB, micro USB, USB-C, barrel connectors, or other charging connectors. The control unit 338 may be comprised of a single button used to cycle the lights 334 through two or more modes, or it may be a single switch, dial, or other user activatable/accessible control. When the control unit 338 is a single button “off” is one of the at least two modes. For example, a control unit 338 comprising a single button with two modes might have a mode for off and another mode for on. In another example embodiment, a control unit 338 might have many modes, such as, off, on, blinking, fast blinking, slow blinking, color rotation, and others.

In another embodiment, the lights may be motion activated. In this embodiment, the control unit includes a motion sensor that serves to start and stop the lights based on motion of the dog or other animal wearing the harness. In another embodiment, the control unit includes motion sensors, such as accelerometers, that can detect the acceleration or direction change of the dog or other animal and activate the lights accordingly. In yet another embodiment, multiple motion sensors may be used to detect each individual footfall of the dog or other animal such that the lights 334 may be activated based on those footfalls. In another embodiment, noise sensors may activate the lights 334 when the dog or other animal wearing the harness barks, growls, or makes other vocalizations. Other numbers and types of modes are contemplated involving, motion, sound and light external to the dog or animal, being caused by the dog or other animal or the user, or other external sources.

The power source 336 and control unit 338 may be removably connected to the harness body or integrated into (and not removable from) the harness body 100. The power source 336 may be included in or coupled to control unit 338. The control unit 338 can be permanently attached to the harness body 100 or removably attached. The control unit 338 can be attached to the harness body 100 using any of the methods described above regarding the connection between abdominal strap 112 and harness body 100 or between breast strap 120 and harness body 100. The control unit 338 may be attached to the harness body 100 via stitching, adhesive, hook and loop fasteners, zippers, buttons, snaps, or with other devices and techniques. In one embodiment, the control unit and the lights each include wireless communication capabilities. This enables the lights to be wirelessly controlled via the control unit. In this wireless embodiment, a separate battery pack (not shown) may be included to power the lights.

In addition to being included or coupled with control unit 338, in other embodiments, the power source 336 can be permanently attached to the harness body 100 or removably attached. The power source 336 can be attached to the harness body 100 using any of the methods described above regarding the connection between abdominal strap 112 and harness body 100 or between breast strap 120 and harness body 100. The power source 336 may be attached to the harness body 100 via stitching, adhesive, hook and loop fasteners, zippers, buttons, snaps, or with other devices and techniques. The power source 336 could be located virtually anywhere on the animal harness, including, but not limited to, inside the padding of the harness body 100, anywhere on top of the harness body 100, or on the ventral strap 119 or front strap 124. In one embodiment, the power source 336 and control unit 338 are attached to the top of the harness body 100 near the handle 330.

In one embodiment, the lights 334 may additionally be wirelessly controlled by a smartphone app. The smartphone may be wirelessly connected to the controller which powers and controls the lights. In this embodiment, the controller supports Bluetooth or other suitable wireless connections that allow for communication with a cell phone app. The lights may be controlled individually or as a group. The app may control all aspects of the lights 334, including frequency, duration, rhythm, intensity, color, hue, saturation, and response time (i.e., the speed with which the lights 334 change intensity or color). The app may also control the lights based on input from the motion sensor. In other configurations the app may, through the controller, direct the lights to, in effect, respond or react to the dog or other animal changing directions or speed based on inertial motion sensors, such as accelerometers included in the controller. Similarly, the app may allow a user to control the lights 334 responsive to input from motion or sound sensors such that the lights may pulse or propagate in response to barks, growls, or other animal or human vocalizations. The smartphone app may come with pre-set light profiles that correspond to the capabilities of the sensors in the controller. The smartphone app may allow a user to program their own light emitting profiles that correspond to user specified stimuli (corresponding to capabilities of sensors included in the controller) provided by in a menu of option in the app.

The smartphone app may additionally configure the lights 334 to respond to control unit 338 in a manner that facilitates training of the dog or other animal. For example, and without limitation, the user may configure the lights 334 to pulse red light by using the control unit 338. The user could train the dog or animal to stop and sit when the user triggers the pulsed red light using control unit 338. For further example, the user could train the dog or animal to turn left or right by using control unit 338 to light only the left or right side of the lights 334, respectively.

### Closing Comments

Throughout this description, the embodiments and examples shown should be considered as exemplars, rather than limitations on the apparatus and procedures disclosed or claimed. Acts, elements and features discussed only in connection with one embodiment are not intended to be excluded from a similar role in other embodiments.

As used herein, “plurality” means two or more. As used herein, a “set” of items may include one or more of such items. As used herein, whether in the written description or the claims, the terms “comprising”, “including”, “carrying”, “having”, “containing”, “involving”, and the like are to be understood to be open-ended, i.e., to mean including but not limited to. Only the transitional phrases “consisting of” and “consisting essentially of”, respectively, are closed or semi-closed transitional phrases with respect to claims. Use of ordinal terms such as “first”, “second”, “third”, etc., in the claims to modify a claim element does not by itself connote any priority, precedence, or order of one claim element over another or the temporal order in which acts of a method are performed, but are used merely as labels to distinguish one claim element having a certain name from another element having a same name (but for use of the ordinal term) to distinguish the claim elements. As used herein, “and/or” means that the listed items are alternatives, but the alternatives also include any combination of the listed items.

It is claimed:

1. An animal harness comprising:
a harness body, the harness body having a front edge, back edge, and side edges, a first connector on a first side edge, and a second connector on the front edge;
a first strap coupled to and extending from a second side edge of the harness body and substantially parallel to the back edge of the harness body;
the first strap having a third connector complimentary to the first connector;
a second strap coupled to and extending from the front edge of the harness body and substantially parallel to the side edges;
the second strap having a fourth connector complimentary to the second connector;
at least one fifth connector attached to the harness body, the at least one fifth connector not centered between the side edges;
a handle connected to the harness body;
a clear sleeve connected to the harness body;
reflective piping on at least one of the front edge, back edge, and side edges of the harness body;
light sources integrated into the reflective piping, wherein the light sources are capable of at least two display modes;
a control unit capable of changing the display modes for the light sources; and
a rechargeable power source for the light sources included in the control unit or as a battery pack included on the harness body.

2. The animal harness of claim 1 wherein at least one of the first strap and the second strap includes reflective material or glow in the dark material.

3. The animal harness of claim 1 wherein the harness body includes webbing, padding, reflective material, or glow in the dark material.

4. The animal harness of claim 1 wherein at least one of the first connector, second connector, third connector, fourth connector and fifth connector is a hook and loop connector, buckle, snap, zipper, button, metal ring, fabric loop, or magnet.

5. The animal harness of claim 1 wherein the harness body has a top side and a bottom side, and the bottom side is a softer, less durable material than the top side.

6. The animal harness of claim 1 wherein the reflective piping is arranged around the perimeter of the harness body.

7. The animal harness of claim 1 wherein at least one display mode of the light sources is motion activated.

8. The animal harness of claim 1 wherein the clear sleeve allows material to be viewed when placed inside the clear sleeve; and
the clear sleeve is polyethylene terephthalate, polycarbonate, polymethyl methacrylate, polyvinyl chloride, or polypropylene.

9. The animal harness of claim 7 wherein the control unit includes wireless communication capabilities and the lights can be wirelessly controlled by the control unit.

10. The animal harness of claim 1 wherein the lights can be wirelessly controlled via a mobile phone app in communication with the control unit, and wherein the control unit includes wireless communication capabilities.

11. The animal harness of claim 10 further comprising:
at least one accelerometer included in the control unit wherein the lights may be programmed by the mobile phone app communicating with the control unit to respond to animal motion based on input from the at least one accelerometer.

12. The animal harness of claim 10 further comprising:
at least one sound sensor included in the control unit, wherein the lights may be programmed by the mobile phone app in communication with the control unit to respond to sound based on input from the at least one sound sensor.

13. The animal harness of claim 10, wherein the lights are programmable by the mobile phone app in communication with the control unit.

14. The animal harness of claim 10 further comprising:
a leash removably connectable to the fifth connector;
the leash comprising the control unit;
the leash comprising a connector to connect the control unit and the light sources.

15. The animal harness of claim 14 further comprising light sources attached to the leash.

16. The animal harness of claim 1 wherein the light sources are LED lights, RGB LED lights, RGBW LED lights, RGBWW LED lights, or OLED lights.

17. The animal harness of claim 16 wherein the light sources are connected to a light string. light pipe, or fiber optic cable.
